(19) United States
(12) Patent Application Publication
(10) Pub. No.: US 2007/0199200 A1
(43) Pub. Date: Aug. 30, 2007

(54) Detachable vehicle guide

(76) Inventor: Rick M. Pardue, Hudson, IN (US)

Correspondence Address: LITMAN LAW OFFICES, LTD., P.O. BOX 15035, CRYSTAL CITY STATION, ARLINGTON, VA, 22215, US

(21) Appl. No.: 11/698,925

(22) Filed: Jan. 29, 2007

Related U.S. Application Data
(60) Provisional application No. 60/776,233, filed on Feb. 24, 2006.

(51) Int. Cl. B60D 1/36

(52) U.S. Cl. 33/264

(57) ABSTRACT

The detachable vehicle guide provides a visual guide for the driver or operator of a vehicle, such as a heavy roadwork vehicle, for maintaining alignment between the vehicle and the side of the road on which the vehicle is driving. The detachable vehicle guide includes a detachable mounting plate for releasable attachment to the vehicle. A bracket extends from the mounting plate, and a rotational mount is pivotally secured to the bracket. A guide rod is secured to the rotational mount, allowing the user to selectively pivotally adjust the guide rod so that the distal end of the guide rod appears to be positioned adjacent the side of the road when the user is driving the vehicle.

### CROSS-REFERENCE TO RELATED APPLICATION

This application claims the benefit of U.S. Provisional Patent Application Ser. No. 60/776,233, filed Feb. 24, 2006.

### BACKGROUND OF THE INVENTION

1. Field of the Invention

The present invention relates to a vehicle alignment or guide devices, and particularly to a detachable vehicle guide that may be attached to a vehicle (such as asphalt pavers, construction vehicles, tractors, etc.) in order to provide the vehicle operator with a guide for operating the vehicle in alignment with a topographical contour, such as the side of the road.

2. Description of the Related Art

Vehicle guides for guiding vehicles are known in the art. Such vehicle guides often take the form of a hood ornament or similar structure, which allows the user to align the vehicle with either the center of the road or with other vehicles. Although in popular use at one time, such guides are ineffective, as there generally is no reference line or demarcation in the center of the road.

Systems for aligning a vehicle with the side of the road have also been utilized. Such systems generally include some sort of rod or frame structure extending over or from the side of the vehicle. Such systems are typically permanently fixed to the automobile and include a variety of mechanical parts that are pivotally joined and extensible with respect to one another. Such systems cannot be efficiently applied to heavy roadwork related vehicles, such as pavers and the like, since the heavy vibration and stress regularly experienced by such vehicles could not maintain a delicate system with many moving parts in proper alignment.

Furthermore, such roadwork vehicles are typically assigned to a multiplicity of users on a day-to-day basis. Thus, the user may wish to mount the visual guide onto a different vehicle. A permanently fixed visual guide does not provide for portability or easy transfer to another vehicle. Further, prior visual guide systems typically require a great deal of adjustment, given their wide variety of pivotal and extensible connections. It would be desirable to provide an easily adjustable guide that could be used in a wide variety of environments. Thus, a detachable vehicle guide solving the aforementioned problems is desired.

### SUMMARY OF THE INVENTION

The detachable vehicle guide provides a visual guide for the driver or operator of a vehicle, such as a heavy roadwork vehicle, for maintaining alignment between the vehicle and the side of the road on which the vehicle is driving. The detachable vehicle guide includes a detachable mounting plate for releasable attachment to a vehicle. The detachable mounting plate may be releasably secured to the vehicle by magnets, hooks or any other suitable releasable fastening elements.

A bracket is mounted on the mounting plate, and a rotational mount is pivotally secured to the bracket. The rotational mount has an engaging portion projecting outwardly therefrom, and may be spring-biased with respect to the bracket. A guide rod is secured to the pivotal mount, allowing the user to selectively pivotally adjust the guide rod so that the distal end of the guide rod appears to be positioned adjacent the side of the road when the user is driving the vehicle.

The guide rod has a proximal end opposite the distal end. An attachment element is joined to the proximal end and releasably engages the engaging portion of the rotational mount. The distal end and the proximal end each have a different color or hue associated therewith, providing the user with an enhanced visual contrast for maintaining alignment of the vehicle.

These and other features of the present invention will become readily apparent upon further review of the following specification and drawings.

### BRIEF DESCRIPTION OF THE DRAWINGS

FIG. 1 is an environmental, perspective view of a detachable vehicle guide according to the present invention, shown attached to the right front side of a machine used in asphalt paving.

FIG. 2 is a side elevation view of the detachable vehicle guide according to the present invention.

FIG. 3 is an exploded perspective view of the detachable vehicle guide according to the present invention.

FIG. 4 is a side elevation view of an alternative embodiment of the detachable vehicle guide according to the present invention.

Similar reference characters denote corresponding features consistently throughout the attached drawings.

### DETAILED DESCRIPTION OF THE PREFERRED EMBODIMENT

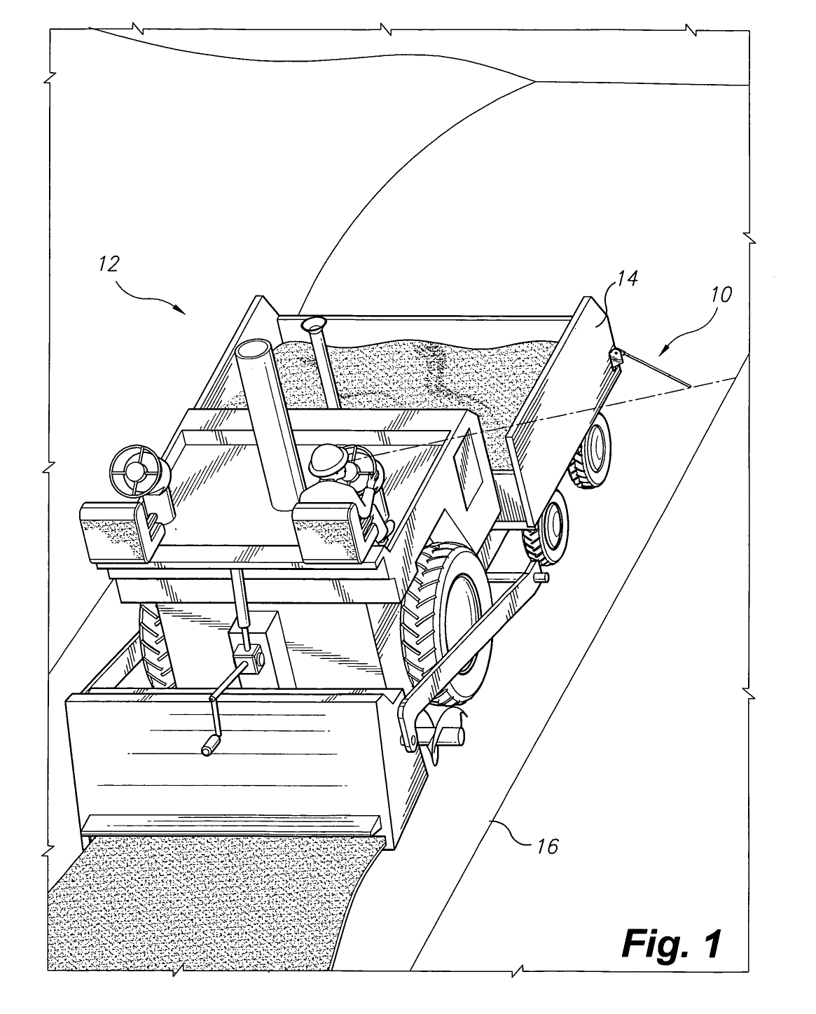

FIG. 1 illustrates the detachable vehicle guide 10 attached to a sidewall 14 of a vehicle or machine 12 used in paving asphalt. The detachable vehicle guide 10 provides a visual guide or marker, which is visually aligned with respect to the driver of the paving machine and the side of the road 16 being paved, aiding the driver in keeping the paving machine 12 a constant distance from the side of the road 16. Although shown attached to a paving machine, it should be understood that the detachable vehicle guide 10 may be applied to any piece of heavy equipment, such as a road painting vehicle, construction vehicles, tractors, etc., or to smaller vehicles, such as an automobile. The vehicle guide 10 may be affixed to any suitable surface or to any suitable vehicle where a visual guide is necessary or desired.

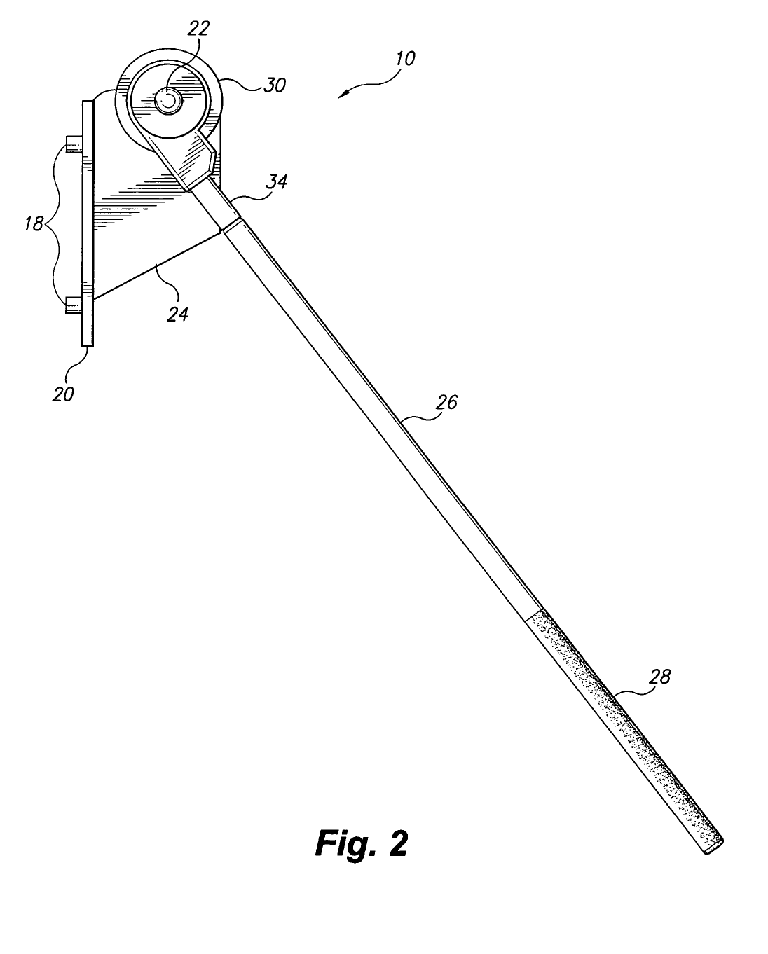

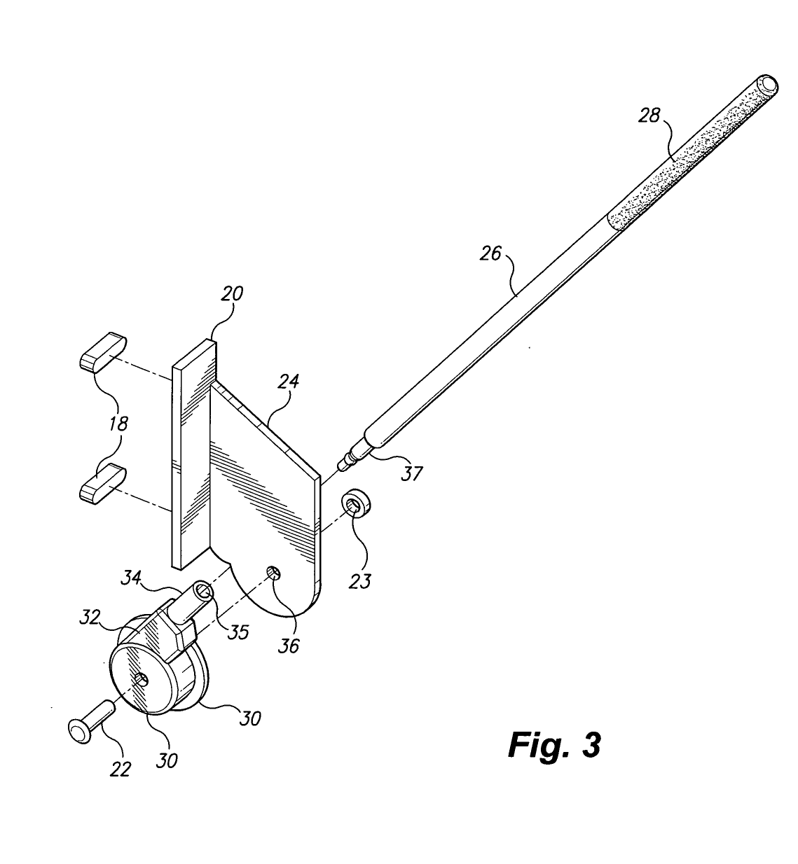

As shown in FIGS. 2 and 3, the detachable vehicle guide 10 includes a mounting plate 20, having a front face and a rear face. The rear face of mounting plate 20 is secured to the vehicle, e.g., to sidewall 14, by releasable attachment elements, such as magnets 18. Although shown in FIGS. 2 and 3 as magnets 18, it should be understood that any suitable releasable fastening means, such as hooks, nuts and bolts or the like, may be used to attach the guide to the vehicle. Further, although shown attached to sidewall 14 in FIG. 1, it will be understood that the detachable vehicle guide 10 may be mounted to any suitable mounting surface, and in the case of magnets 18, to any suitable ferromagnetic surface, e.g., a bumper.

Bracket 24 is mounted to the front face of mounting plate 20, and extends substantially orthogonally and forwardly therefrom. An opening 36 is formed through bracket 24, allowing the rotational mount 30 to be pivotally secured to the bracket 24 by a pivotal attachment element, such as nut and bolt 22, 23, respectively. It should be understood that the pivotal attachment element may be any suitable attachment element, such as a pivot pin, a screw or the like.

Although shown as having distinctive contouring in FIGS. 2 and 3, it should be understood that the size and shape of mounting plate 20 and bracket 24 may differ from that shown in the drawings. Bracket 24 and mounting plate 20 are formed from a high-strength, rugged material, such as steel, iron, hard plastic or the like.

A projecting member 32 extends from rotational mount 30, and supports shaft 34, which has an axial recess 35 formed therein. Recess 35 receives connector 37, which is formed on the proximal end of guide rod 26. Connector 37 is releasably locked within recess 35 when the vehicle guide 10 is in use. During transport, guide rod 26 may be selectively detached from rotational mount 30 by disengaging connector 37 from shaft 34. Connector 37 may be shaped, as shown, to frictionally engage the walls defining recess 35, or may be any other suitable releasable fixture, such as a threaded stud.

As shown, the distal portion 28 of guide rod 26 has a different color than the proximal portion, in order to make distal portion 28 visually distinct. This distinction aids the driver in aligning the distal end of the guide rod 26 against the edge of the road when the vehicle guide 10 is in use. The distal end 28 may also have a differing texture or may be formed from different materials, such as a reflective material, in order to provide further visual distinctiveness. Further, guide rod 26 may be telescopic, allowing the length of guide rod 26 to be adjusted for use with a variety of vehicles.

In use, the detachable vehicle guide 10 is releasably secured to the vehicle 12 through use of magnets 18. The guide rod 26 is releasably secured to the rotational mount 30 through engagement of engaging element 37 with engaging portion 34. The guide rod 26 and rotational mount 30 are selectively rotated with respect to bracket 24, so that the distal end of guide rod 26 is visually aligned with the side of the road, when viewed by the driver of the vehicle. Rotational mount 30 may be a spring-load, spider-type swivel mount, which provides quick and easy adjustment of the angle of rotation of guide rod 26 from 0° to 180°, and also allows guide rod 26 to quickly collapse when accidentally struck by another vehicle or load in order to avoid damage to the guide rod 26. Vibration and stress associated with the movement of the vehicle 12 can cause angular misalignment, so that rotational mount 30 must be held securely in place with respect to bracket 24, through frictional engagement therewith, through spring-biasing, or the like. In order to transport the device 10, or transfer the device 10 to another vehicle, the vehicle guide 10 may be easily removed from the vehicle and the guide rod 26 can be disengaged from engaging portion 34 of rotational mount 30.

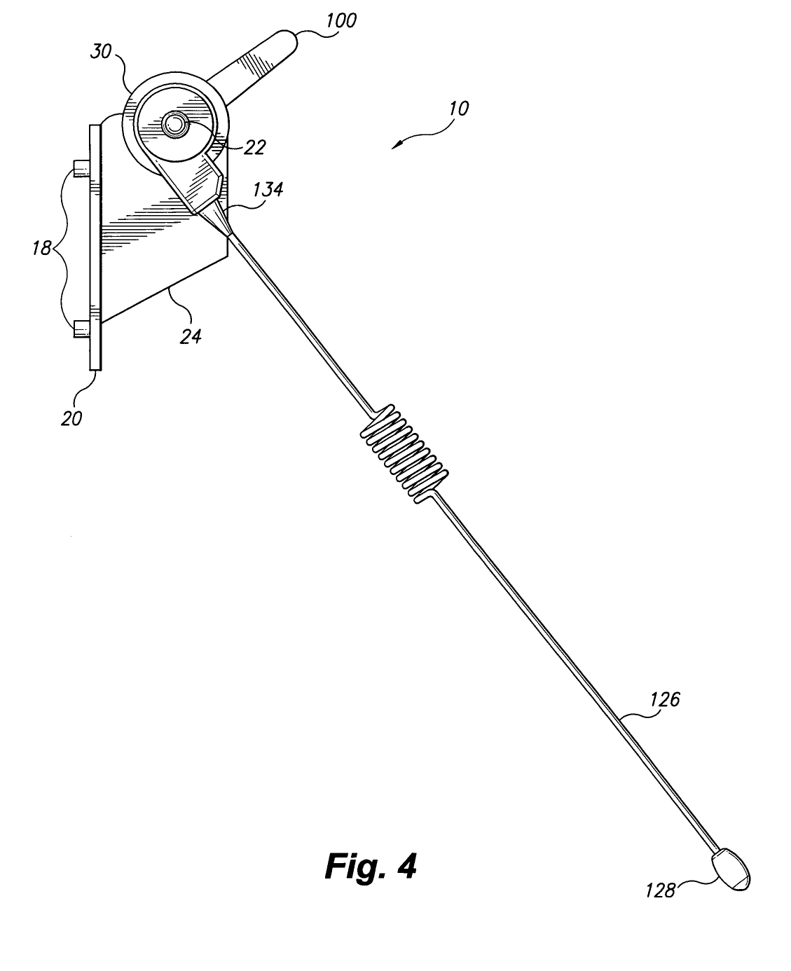

In the alternative embodiment of FIG. 4, guide rod 26 is replaced with a relatively thinner-profile rod 126 which, preferably, has greater flexibility and a more elastic nature than the thicker rod 26 of FIGS. 1-3. Preferably, a bead 128 or other visually distinct element is mounted on the free end of guide rod 126, as illustrated. Bead 128 provides a visual indicator for the driver, replacing the visually-distinct distal end 28 of FIGS. 1-3. Guide rod 126 is mounted to an engaging portion 134 (similar to engaging portion 34 of the embodiment of FIGS. 1-3), which may have a substantially tapered contour, as shown, in order to accommodate the thinner profile of guide rod 126. Further, a handle 100 may be mounted to rotational mount 30, allowing the user a gripping surface for the selective rotation and positioning of the guide rod 126.

It is to be understood that the present invention is not limited to the embodiment described above, but encompasses any and all embodiments within the scope of the following claims.

I claim:

1. A detachable vehicle guide, comprising:
a mounting plate;
a bracket extending from the mounting plate;
a rotational mount attached to the bracket, the rotational mount having a shaft extending therefrom;
means for detachably mounting said mounting plate to a vehicle; and,
a guide rod having a proximal end attached to the shaft and a distal end, whereby the mounting plate is adapted for attachment to the vehicle so that the guide rod is adjustable lateral to the vehicle in order to provide an alignment guide for an operator of the vehicle.

2. The detachable vehicle guide as recited in claim 1, wherein said means for detachably mounting said mounting plate comprises at least one magnet.

3. The detachable vehicle guide as recited in claim 1, wherein the distal end of said guide rod has a first color associated therewith and the proximal end of said guide rod has a second color associated therewith, the second color being distinct from the first color, so that the distal end is readily discernable to the operator of the vehicle.

4. The detachable vehicle guide as recited in claim 1, wherein the shaft is mounted so as to be rotatable between approximately 0° and 180° with respect to said bracket.

5. The detachable vehicle guide as recited in claim 1, further comprising means for releasably attaching the proximal end of said guide rod to the shaft.

6. The detachable vehicle guide as recited in claim 5, wherein said shaft has a recess formed therein, an engaging portion of the proximal end of said guide rod being releasably received within the recess.

7. The detachable vehicle guide as recited in claim 1, further comprising a visual indicator being mounted on the distal end of said guide rod.

8. The detachable vehicle guide as recited in claim 7, wherein the visual indicator comprises a bead.

9. The detachable vehicle guide as recited in claim 1, further comprising a handle member secured to said rotational mount and extending outwardly therefrom.

10. The detachable vehicle guide as recited in claim 1, further comprising means for pivotally joining said rotational mount to said bracket.

11. The detachable vehicle guide as recited in claim 10, wherein said means for pivotally joining said rotational mount to said bracket comprises a nut and a bolt, a shaft of said bolt being received through a passage formed through said rotational mount and an opening formed through said bracket.
